(19) United States
(12) Patent Application Publication
(10) Pub. No.: US 2012/0213144 A1
(43) Pub. Date: Aug. 23, 2012

(54) SPATIAL TECHNIQUES FOR EVOLVED MULTIMEDIA BROADCAST MULTICAST SERVICE ENHANCEMENT

(75) Inventors: Xiaoxia Zhang, San Diego, CA (US); Yongbin Wei, San Diego, CA (US); Durga Prasad Malladi, San Diego, CA (US)

(73) Assignee: QUALCOMM INCORPORATED, San Diego, CA (US)

(21) Appl. No.: 13/402,799

(22) Filed: Feb. 22, 2012

Related U.S. Application Data
(60) Provisional application No. 61/445,986, filed on Feb. 23, 2011.

(51) Int. Cl. H04W 4/06; H04H 20/71

(52) U.S. Cl. 370/312

(57) ABSTRACT

Transmission of eMBMS signals by at least one network entity of a wireless communications system may include coordinating transmission of eMBMS signaling with a remote access point of a wireless communications system to broadcast the eMBMS signaling from a multiple antenna matrix comprising at least one antenna of the network entity and at least one antenna of the access node. The network entity may be an access point. The access point may vary a precoding matrix applied to the eMBMS signaling to transmit from the network entity, or use alternative techniques for providing transmit diversity. Accordingly, the access point may provide transmit diversity for the eMBMS signaling transmitted from the multiple antenna matrix implemented between different cells on the wireless communication network. The access point may vary the precoding matrix to cause cyclical rotation of beam direction for the eMBMS transmissions from different cells of the network.

### CROSS-REFERENCE TO RELATED APPLICATION

This application claims priority pursuant to 35 U.S.C. §119(e) to U.S. provisional application Ser. No. 61/445,986, filed Feb. 23, 2011, which is hereby incorporated by reference, in its entirety.

### FIELD

Aspects of the present disclosure relate generally to wireless communication systems, and more particularly, to providing spatial diversity techniques for Evolved Multimedia Broadcast Multicast (eMBMS) enhancement.

### BACKGROUND

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

The 3rd Generation Partnership Project (3GPP) Long Term Evolution (LTE) represents a major advance in cellular technology as an evolution of Global System for Mobile communications (GSM) and Universal Mobile Telecommunications System (UMTS). The LTE physical layer (PHY) provides a highly efficient way to convey both data and control information between base stations, such as an evolved Node Bs (eNBs), and mobile entities, such as UEs. In prior applications, a method for facilitating high bandwidth communication for multimedia has been single frequency network (SFN) operation. SFNs utilize radio transmitters, such as, for example, eNBs, to communicate with subscriber UEs. In unicast operation, each eNB is controlled so as to transmit signals carrying information directed to one or more particular subscriber UEs. The specificity of unicast signaling enables person-to-person services such as, for example, voice calling, text messaging, or video calling.

In broadcast operation, several eNBs in a broadcast area are controlled to broadcast signals in a synchronized fashion, carrying information that can be received and accessed by any subscriber UE in the broadcast area. The generality of broadcast operation enables greater efficiency in transmitting information of general public interest, for example, event-related multimedia broadcasts. As the demand and system capability for event-related multimedia and other broadcast services has increased, system operators have shown increasing interest in making use of broadcast operation in 3GPP networks. In the past, 3GPP LTE technology has been primarily used for unicast service, leaving opportunities for improvements and enhancements related to broadcast signaling.

### SUMMARY

Methods, apparatus and systems for providing spatial diversity for eMBMS enhancement in a wireless communication system are described in detail in the detailed description, and certain aspects are summarized below. This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In an aspect, a method for transmission of eMBMS signals by at least one network entity of a wireless communications system may include coordinating transmission of eMBMS signaling with a remote access node of a wireless communications system to broadcast the eMBMS signaling from a multiple antenna matrix comprising at least one antenna of the network entity and at least one antenna of the access node. The network entity may be, or may include, an access node of the network. In an aspect, the method may include varying a precoding matrix applied to the eMBMS signaling to transmit from the network entity. Consequently, the multiple antenna matrix may provide transmit diversity for the eMBMS signaling between different cells on the wireless communication network.

In an aspect, the method may further include varying the precoding matrix to cause cyclical rotation of beam direction for the eMBMS transmissions from different cells of the network. The cyclical rotation may be coordinated so that the beam direction is aligned to corresponding sectors of the access node at simultaneous (or near-simultaneous) times. In this arrangement, each location within the network should be within a beam from a different one of several nearby access nodes during corresponding periods of the cyclical rotation. Thus, a mobile entity receives the eMBMS signaling from several different transmitters over each cycle, and may thereby avoid the disadvantage of receiving the eMBMS signaling from a single transmitter.

In another aspect, the method may include communicating with the access node to coordinate (e.g., synchronize or coordinate phase of) the eMBMS signaling within an eMBMS area of the wireless communication system. For example, each access node may be assigned to a different angular offset of the cyclical rotation, and each offset assignment may be distributed over the eMBMS area to maximize coverage within the area. Special procedures may be adopted for access nodes located at or near the edge of the eMBMS area.

In an alternative aspect, the method may further include varying the precoding matrix to cause cyclic delay diversity based spatial multiplexing of the broadcast eMBMS signaling. In such embodiments, the method may also include communicating with at least one remote access node of the wireless communications system to coordinate phase of the cyclic delay diversity based spatial multiplexing among nodes within an eMBMS area. In an alternative, or in addition, the method may include communicating with at least one remote access node of the wireless communications system to synchronize the cyclic delay diversity based spatial multiplexing among nodes within an eMBMS area.

In another aspect, the method may include providing transmit diversity for the eMBMS signaling from the multiple antenna matrix by applying phase variation to the eMBMS signaling. In an alternative, or in addition, the method may include providing transmit diversity for the eMBMS signaling from the multiple antenna matrix by implementing a Space-Frequency Block Coding (SFBC) technique for the eMBMS signaling.

In another aspect, a method for transmission of eMBMS signals by at least one network entity of a wireless communications system may include modulating a first layer of eMBMS signaling for reception by a first receiver and a second receiver. The method may include modulating a second layer of the eMBMS signaling for reception by the second receiver only, such that the second layer encodes additional information not encoded in the first layer. The network entity may separate information for an eMBMS service for modulating in first layer and information that is merely supplemental or ancillary for the eMBMS service for modulating in the second layer. The method may include transmitting the second layer superposed on the first layer and having a different energy level. The method may further include transmitting the first and second layers using antenna virtualization to maximize antenna power. The method may further include communicating with at least one remote access node of the wireless communications system to coordinate the eMBMS signaling within an eMBMS area of the wireless communication system, for example according to more detailed aspects of the first method summarized above.

In a complementary aspect, a method for receiving eMBMS signals by at least one mobile entity of a wireless communications system may include demodulating a first layer of eMBMS signaling to obtain first eMBMS information. The method may further include demodulating a second layer of the eMBMS signaling to obtain additional eMBMS information not encoded in the first layer. In an aspect, the second layer may be superposed on the first layer and may have a different energy level than the first layer. The additional eMBMS information may relate to additional content that is ancillary to primary content in the first eMBMS information.

In related aspects, a wireless communications apparatus may be provided for performing any of the methods and aspects of the methods summarized above. An apparatus may include, for example, a processor coupled to a memory, wherein the memory holds instructions for execution by the processor to cause the apparatus to perform operations as described above. Certain aspects of such apparatus (e.g., hardware aspects) may be exemplified by equipment such as mobile entities or base stations of various types used for wireless communications. Similarly, an article of manufacture may be provided, including a non-transitory computer-readable medium holding encoded instructions, which when executed by a processor, cause a wireless communications apparatus to perform the methods and aspects of the methods as summarized above.

All of the operations of the foregoing methods may be performed by a network entity of the wireless communication system, using components as described in more detail elsewhere herein. Although any of these methods may be used to provide spatial diversity for eMBMS enhancement, they may also be used to provide spatial diversity using other protocols for multimedia broadcast multicast service in a cellular wireless communication system.

### BRIEF DESCRIPTION OF THE DRAWINGS

FIG. 1 is a block diagram conceptually illustrating an example of a telecommunications system.

FIG. 2 is a block diagram conceptually illustrating an example of a down link frame structure in a telecommunications system.

FIG. 3 is a block diagram conceptually illustrating is a block diagram conceptually illustrating a design of a base station/eNB and a UE configured according to one aspect of the present disclosure.

FIG. 4A discloses a continuous carrier aggregation type.

FIG. 4B discloses a non-continuous carrier aggregation type.

FIG. 5 discloses MAC layer data aggregation.

FIG. 6 illustrates an existing allocation of MBSFN reference signals on MBSFN subframes.

FIG. 7 illustrates an existing allocation of unicast reference signals on non-MBSFN subframes.

FIG. 8 illustrates an embodiment of eMBMS enhancements using spatial techniques with remote antennas.

FIG. 9 illustrates an embodiment using coordinated beam steering for eMBMS transmissions within an eMBMS area.

FIG. 10 illustrates layer modulation for eMBMS transmission.

FIG. 11 illustrates an embodiment of a methodology for eMBMS enhancements using spatial techniques, performed at a network entity.

FIG. 12 illustrates an embodiment of an apparatus for eMBMS enhancements using spatial techniques, in accordance with the methodology of FIG. 11.

FIGS. 13 and 14A-C illustrate embodiments of a methodology for eMBMS enhancements by varying a precoding matrix applied to eMBMS signaling, performed at a network entity.

FIG. 15 illustrates an embodiment of an apparatus for eMBMS enhancements using cyclic spatial multiplexing, in accordance with the methodologies of FIGS. 13 and 14A-C.

FIG. 16 illustrates an embodiment of a methodology for eMBMS enhancements using layered modulation, performed at a network entity.

FIG. 17 shows further aspects of the methodology of FIG. 16.

FIG. 18 illustrates an embodiment of an apparatus for eMBMS enhancements using layered modulation, in accordance with the methodologies of FIGS. 16 and 17.

FIG. 19 illustrates an embodiment of a methodology for eMBMS enhancements using layered demodulation, performed at a mobile entity.

FIG. 20 illustrates an embodiment of an apparatus for eMBMS enhancements using layered demodulation, in accordance with the methodology of FIG. 19.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

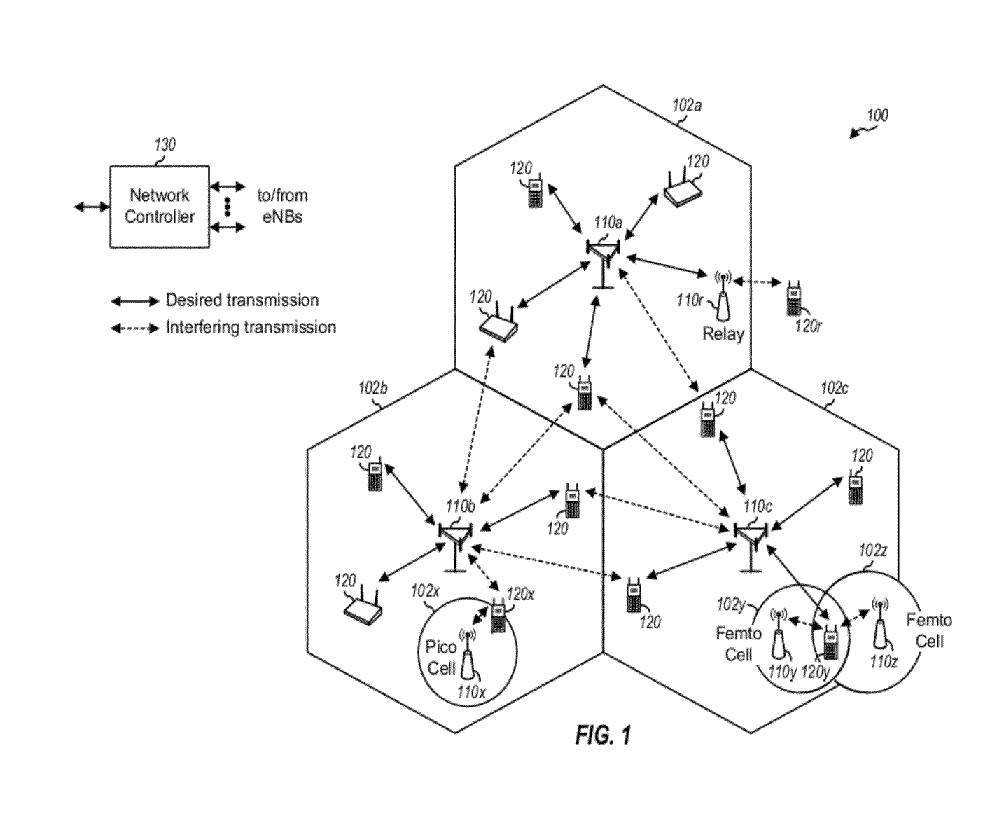

FIG. 1 shows a wireless communication network 100, which may be an LTE network. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a corresponding particular geographic area 102a, 102b, 102c. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB (HNB). In the example shown in FIG. 1, the eNBs 110a, 110b and 110c may be macro eNBs for the macro cells 102a, 102b and 102c, respectively. The eNB 110x may be a pico eNB for a pico cell 102x. The eNBs 110y and 110z may be femto eNBs for the femto cells 102y and 102z, respectively. An eNB may support one or multiple (e.g., three) cells.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, for example, macro eNBs, pico eNBs, femto eNBs, or relays. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul connection. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile entity, a mobile station, a subscriber unit, a station, or other terminology. A UE may be a cellular phone, a personal digital assistant (PDA), a wireless modem, a wireless communication device, a handheld device, a laptop computer, a cordless phone, a wireless local loop (WLL) station, or other mobile entities. A UE may be able to communicate with macro eNBs, pico eNBs, femto eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones or bins. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

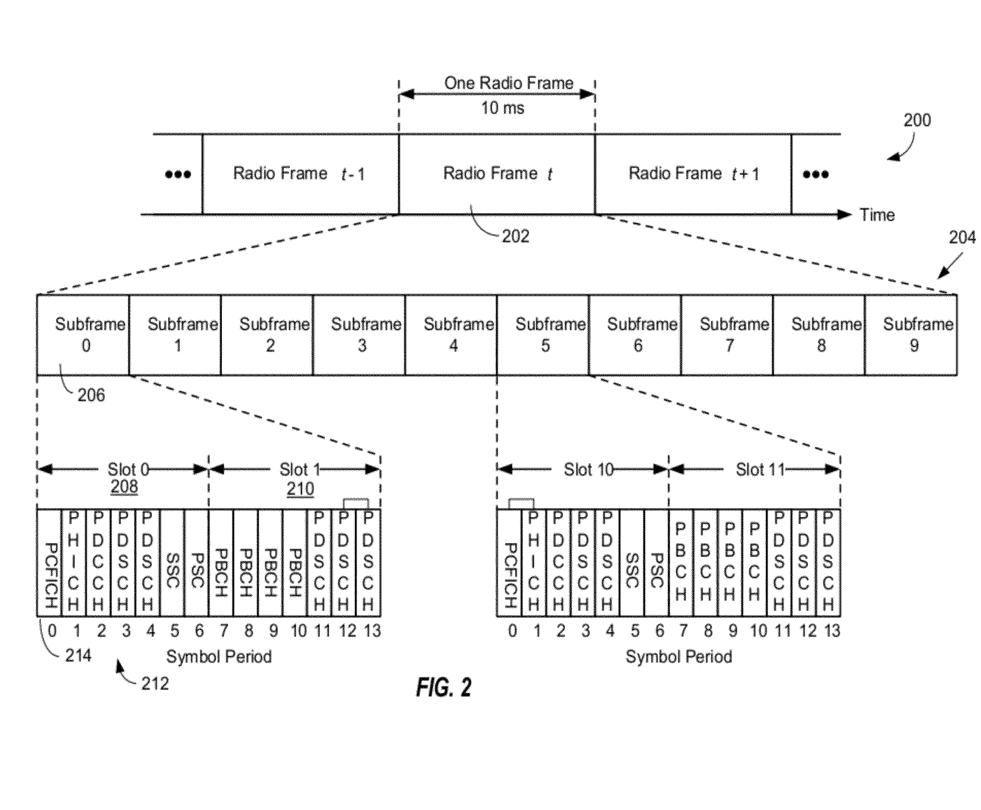

FIG. 2 shows a down link frame structure used in LTE. The transmission timeline for the downlink may be partitioned into units of radio frames 200. Each radio frame, for example, frame 202, may have a predetermined duration (e.g., 10 milliseconds (ms)) and may be partitioned into 10 subframes 204 with indices of 0 through 9. Each subframe, for example ‘Subframe 0’ 206, may include two slots, for example, ‘Slot 0’ 208 and ‘Slot 1’ 210. Each radio frame may thus include 20 slots with indices of 0 through 19. Each slot may include ‘L’ symbol periods, e.g., 7 symbol periods 212 for a normal cyclic prefix (CP), as shown in FIG. 2, or 6 symbol periods for an extended cyclic prefix. The normal CP and extended CP may be referred to herein as different CP types. The 2L symbol periods in each subframe may be assigned indices of 0 through 2L-1. The available time frequency resources may be partitioned into resource blocks. Each resource block may cover ‘N’ subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in only a portion of the first symbol period of each subframe, although depicted in the entire first symbol period 214 in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on resource allocation for UEs and control information for downlink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

A UE may be within the coverage of multiple eNBs. One of these eNBs may be selected to serve the UE. The serving eNB may be selected based on various criteria such as received power, path loss, signal-to-noise ratio (SNR), etc.

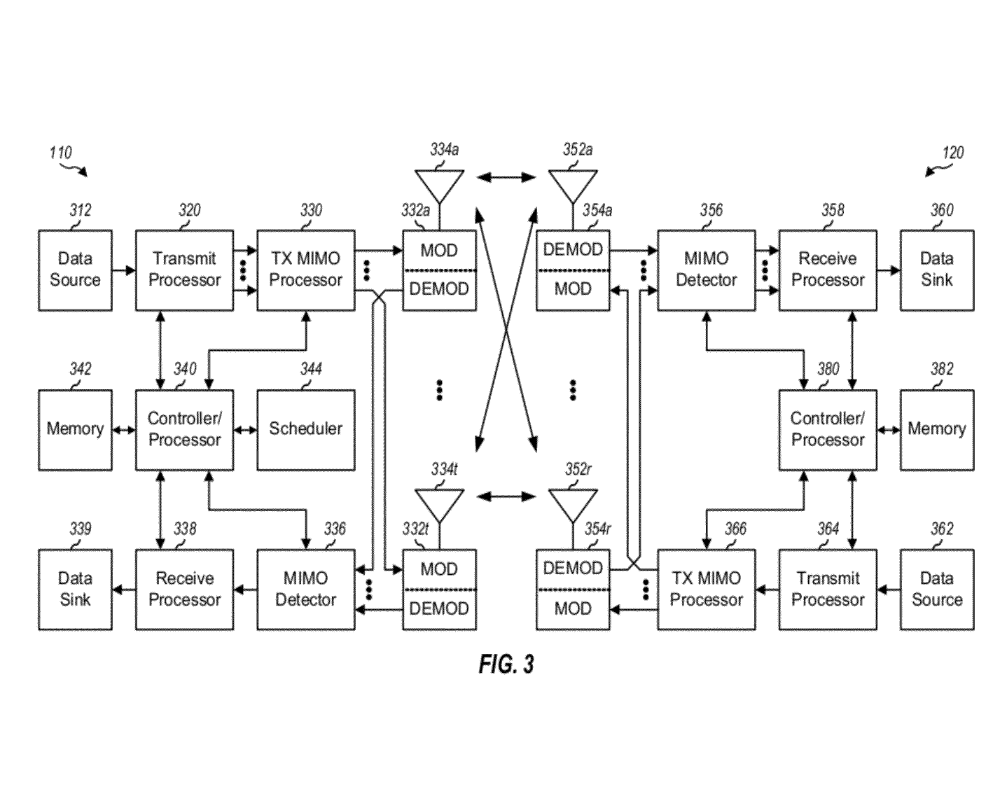

FIG. 3 shows a block diagram of a design of a base station/eNB 110 and a UE 120, which may be one of the base stations/eNBs and one of the UEs in FIG. 1. For example, the base station 110 may be the macro eNB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

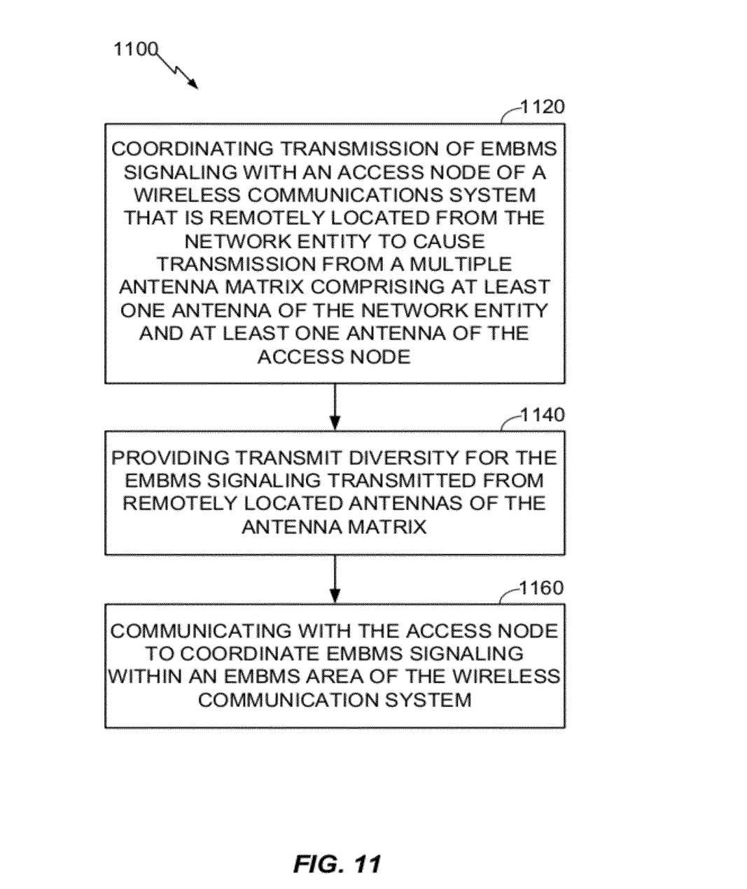

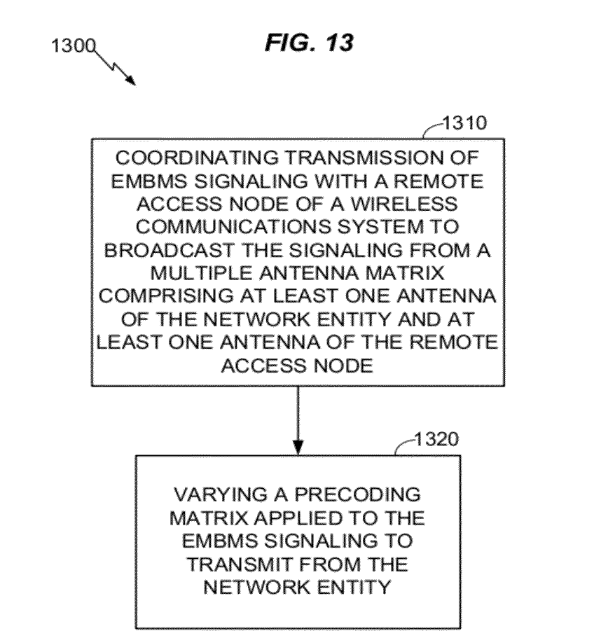

At the base station 110, a transmit processor 320 may receive data from a data source 312 and control information from a controller/processor 340. The control information may be for the PBCH, PCFICH, PHICH, PDCCH, etc. The data may be for the PDSCH, etc. In addition, the processor 340 and/or other processors and modules at the eNB 110 may also perform or direct the execution of the functional blocks illustrated in FIGS. 11, 13, 14A-C, 16, or 17, and/or other processes for the techniques described herein. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc.), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

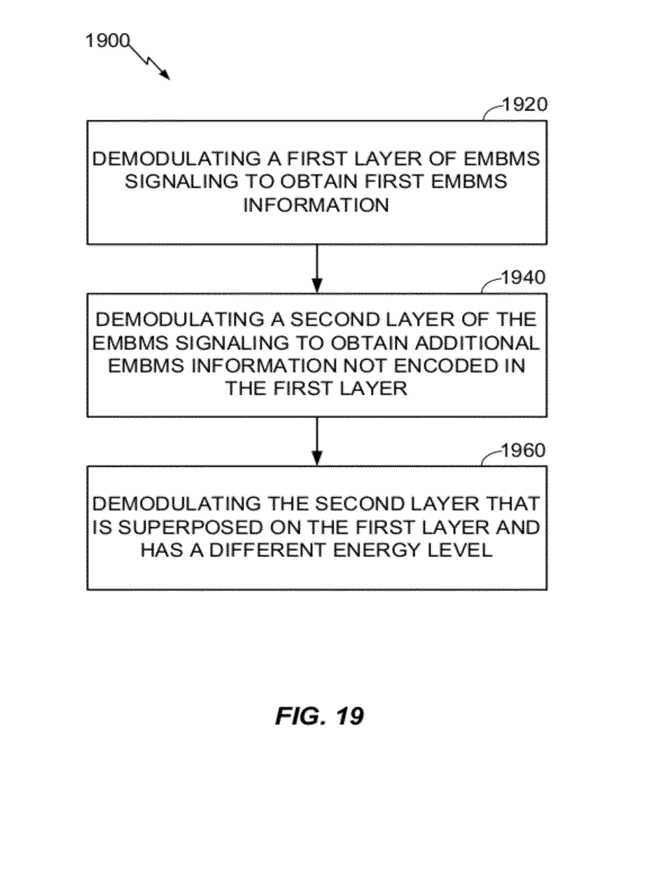

The controllers/processors 340 and 380 may direct the operation at the base station 110 and the UE 120, respectively. The processor 340 and/or other processors and modules at the base station 110 may perform or direct the execution of various processes for the techniques described herein. The processor 380 and/or other processors and modules at the UE 120 may also perform or direct the execution of the functional blocks illustrated in FIG. 19, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 380, the memory 382, the receive processor 358, the MIMO detector 356, the demodulators 354a, and the antennas 352a configured to perform the functions recited by the aforementioned means. In another aspect, the aforementioned means may be a module or any apparatus configured to perform the functions recited by the aforementioned means.

### Carrier Aggregation

LTE-Advanced UEs use spectrum in 20 Mhz bandwidths allocated in a carrier aggregation of up to a total of 100 Mhz (5 component carriers) used for transmission in each direction. Generally, less traffic is transmitted on the uplink than the downlink, so the uplink spectrum allocation may be smaller than the downlink allocation. For example, if 20 Mhz is assigned to the uplink, the downlink may be assigned 100 Mhz. These asymmetric FDD assignments will conserve spectrum and are a good fit for the typically asymmetric bandwidth utilization by broadband subscribers.

### Carrier Aggregation Types

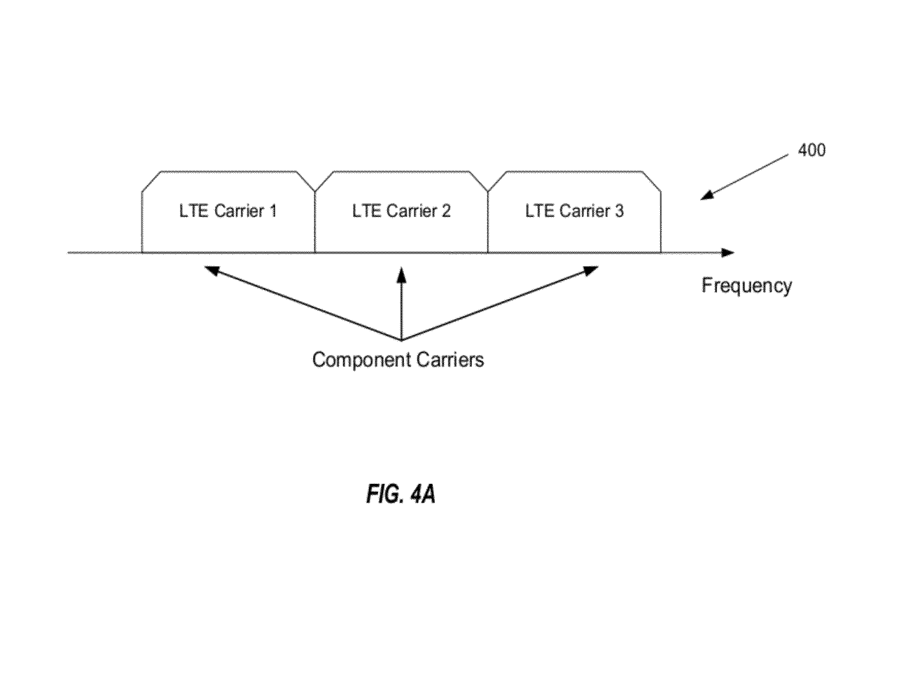

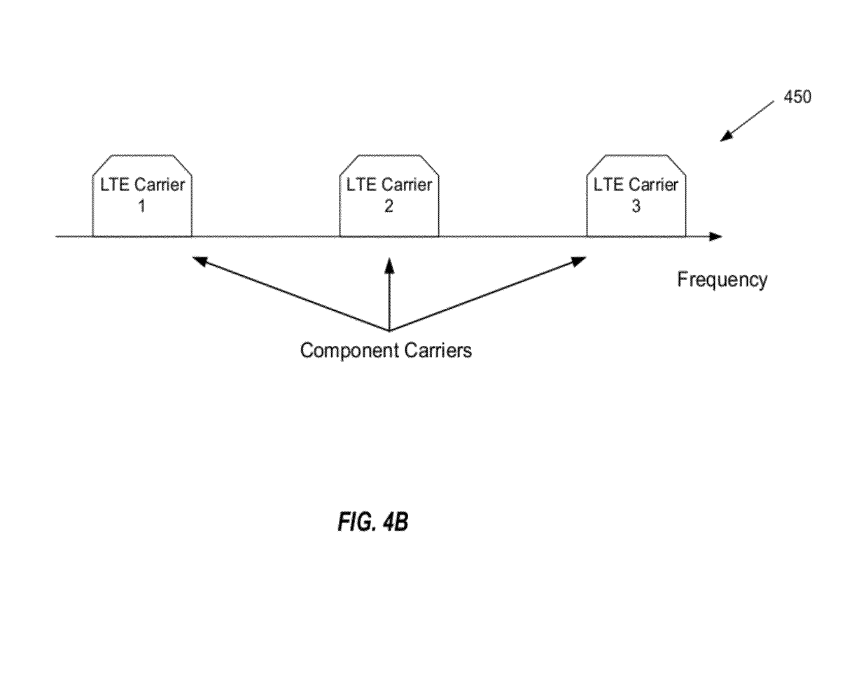

For the LTE-Advanced mobile systems, two types of carrier aggregation (CA) methods have been proposed, continuous CA and non-continuous CA. They are illustrated in FIGS. 4A and 4B. Non-continuous CA occurs when multiple available component carriers 450 are separated along the frequency band (FIG. 4B). On the other hand, continuous CA occurs when multiple available component carriers 400 are adjacent to each other (FIG. 4A). Both non-continuous and continuous CA aggregate multiple LTE/component carriers to serve a single unit of LTE Advanced UE.

Multiple RF receiving units and multiple FFTs may be deployed with non-continuous CA in LTE-Advanced UE since the carriers are separated along the frequency band. Because non-continuous CA supports data transmissions over multiple separated carriers across a large frequency range, propagation path loss, Doppler shift and other radio channel characteristics may vary a lot at different frequency bands.

Thus, to support broadband data transmission under the non-continuous CA approach, methods may be used to adaptively adjust coding, modulation and transmission power for different component carriers. For example, in an LTE-Advanced system where the enhanced NodeB (eNB) has fixed transmitting power on each component carrier, the effective coverage or supportable modulation and coding of each component carrier may be different.

### Data Aggregation Schemes

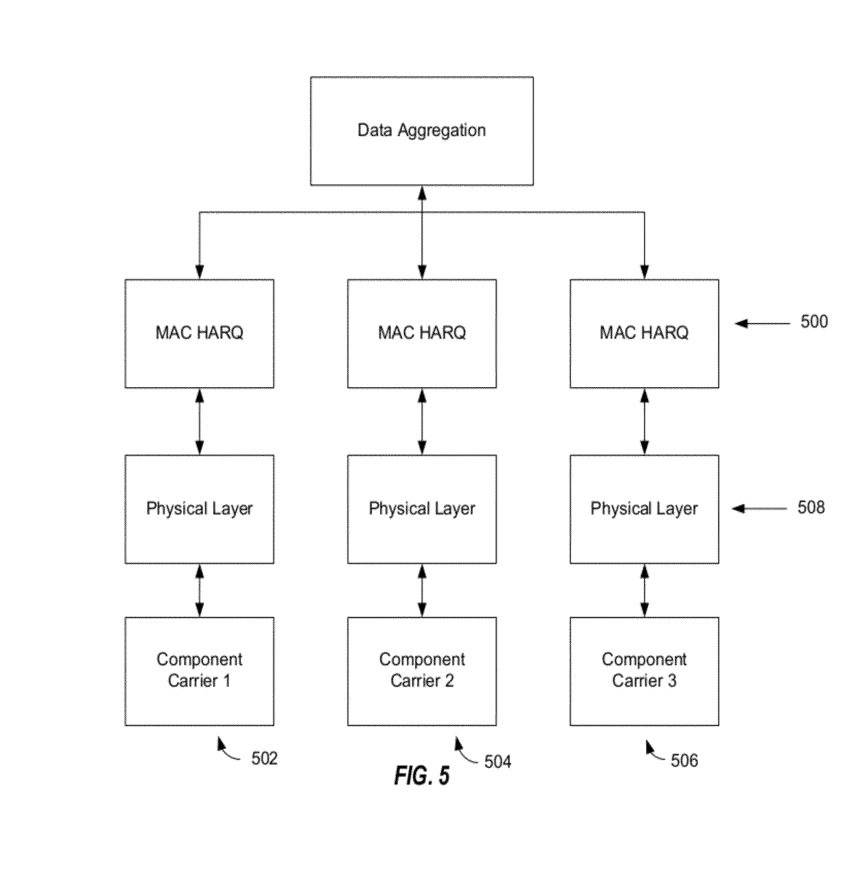

FIG. 5 illustrates aggregating transmission blocks (TBs) from different component carriers 502, 504, 506 at the medium access control (MAC) layer 500 for an IMT-Advanced system. With MAC layer data aggregation, each component carrier has its own independent hybrid automatic repeat request (HARQ) entity in the MAC layer 500 and its own transmission configuration parameters (e.g., transmitting power, modulation and coding schemes, and multiple antenna configuration) in the physical layer. Similarly, in the physical layer 508, one HARQ entity is provided for each component carrier.

### Control Signaling

In general, there are three different approaches for deploying control channel signaling for multiple component carriers. The first involves a minor modification of the control structure in LTE systems where each component carrier is given its own coded control channel.

The second method involves jointly coding the control channels of different component carriers and deploying the control channels in a dedicated component carrier. The control information for the multiple component carriers will be integrated as the signaling content in this dedicated control channel. As a result, backward compatibility with the control channel structure in LTE systems is maintained, while signaling overhead in the CA is reduced.

Multiple control channels for different component carriers are jointly coded and then transmitted over the entire frequency band formed by a third CA method. This approach offers low signaling overhead and high decoding performance in control channels, at the expense of high power consumption at the UE side. However, this method is not compatible with LTE systems.

eMBMS and Unicast Signaling in Single Frequency Networks

One mechanism to facilitate high bandwidth communication for multimedia has been single frequency network (SFN) operation. Particularly, Multimedia Broadcast Multicast Service (MBMS) and MBMS for LTE, also known as evolved MBMS (eMBMS) (including, for example, what has recently come to be known as multimedia broadcast single frequency network (MBSFN) in the LTE context), may utilize such SFN operation. SFNs utilize radio transmitters, such as, for example, eNBs, to communicate with subscriber UEs. Groups of eNBs can transmit bi-directional information in a synchronized manner, so that signals reinforce one another rather than interfere with each other. In the context of of eMBMS, there remains a need for single carrier optimization for transmitting shared content from a LTE network to multiple UEs.

In accordance with aspects of the subject of this disclosure, there is provided a wireless network (e.g., a 3GPP network) having features relating to single carrier optimization for eMBMS. eMBMS provides an efficient way to transmit shared content from an LTE network to multiple mobile entities, such as, for example, UEs.

With respect a physical layer (PHY) of eMBMS for LTE FDD, the channel structure may comprise time division multiplexing (TDM) resource partitioning between an eMBMS and unicast transmissions on mixed carriers, thereby allowing flexible and dynamic spectrum utilization. Currently, a subset of subframes (up to 60%), known as MBSFN subframes, can be reserved for eMBMS transmission. As such current eMBMS design allows at most six out of ten subframes for eMBMS.

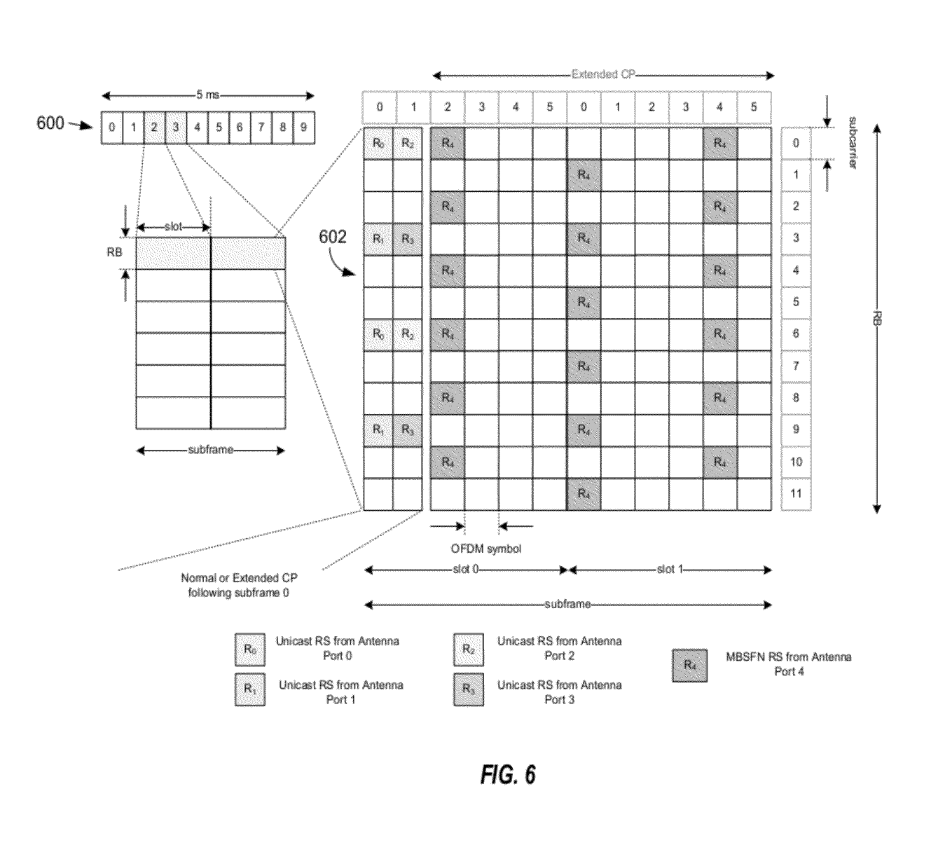

An example of subframe allocation for eMBMS is shown in FIG. 6, which shows an existing allocation of MBSFN reference signals on MBSFN subframes, for a single-carrier embodiment. Components depicted in FIG. 6 correspond to those shown in FIG. 2, with FIG. 6 showing the individual subcarriers within each slot and resource block (RB). In 3GPP LTE, an RB spans 12 subcarriers over a slot duration of 0.5 ms, with each subcarrier having a bandwidth of 15 kHz together spanning 180 kHz per RB. Subframes may be allocated for unicast or eMBMS; for example in a sequence of subframes 600 labeled 0, 1, 2, 3, 4, 5, 6, 7, 8, and 9, subframes 0, 4, 5, and 9 may be excluded from eMBMS in FDD. Also, subframes 0, 1, 5, and 6 may be excluded from eMBMS in time division duplex (TDD). More specifically, subframes 0, 4, 5, and 9 may be used for PSS/SSS/PBCH/paging/system information blocks (SIBs) and unicast service. Remaining subframes in the sequence, e.g., subframes 1, 2, 3, 6, 7, and 8 may be configured as eMBMS subframes.

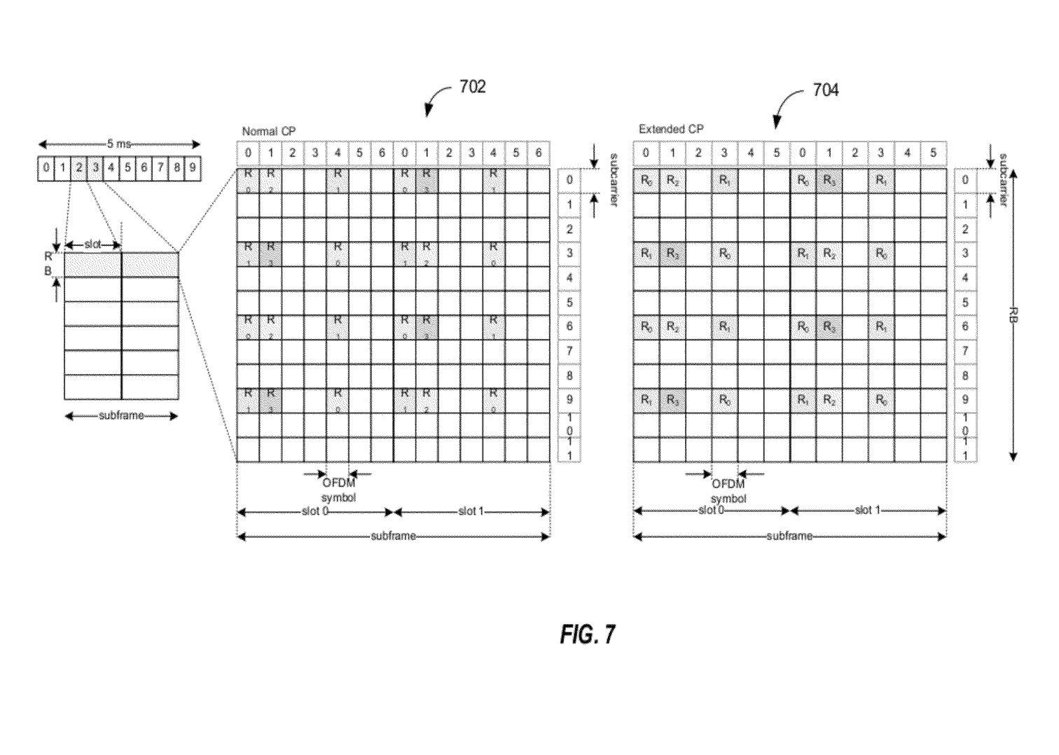

With continued reference to FIG. 6, within each eMBMS subframe 602, the first 1 or 2 symbols may be used for unicast reference symbols (RSs) and control signaling. A CP length of the first 1 or 2 symbols may follow that of subframe 0. A transmission gap may occur between the first 1 or 2 symbols and the eMBMS symbols if the CP lengths are different. In related aspects, the overall eMBMS bandwidth utilization may be 42.5% considering RS overhead (e.g., 6 eMBMS subframes and 2 control symbols within each eMBMS subframe). Known techniques for providing MBSFN RSs and unicast RSs typically involve allocating the MBSFN RSs on MBSFN subframes (for example, subframe 602 as shown in FIG. 6), and separately allocating unicast RSs on non-MBSFN subframes (not shown). More specifically, as FIG. 6 shows, the extended CP of the MBSFN subframe includes MBSFN RSs but not unicast RSs. In further related aspects, the unicast RSs may be on the non-eMBMS subframes, as illustrated in the embodiment of FIG. 7, which shows an existing allocation of unicast reference signals on non-MBSFN subframes 702, 704. As FIG. 7 shows, the normal CP 702 and/or extended CP 704 of the non-MBSFN subframes include unicast RSs but not MBSFN RSs.

### Spatial Techniques for Embms Enhancement

In contexts as described by the foregoing introduction, various spatial techniques may be used to improve or enhance performance of eMBMS in wireless communication networks. Spatial techniques as discussed below may be grouped into three categories of embodiments: transmit diversity, MIMO/beam steering, and layered modulation. These embodiments will be discussed in turn.

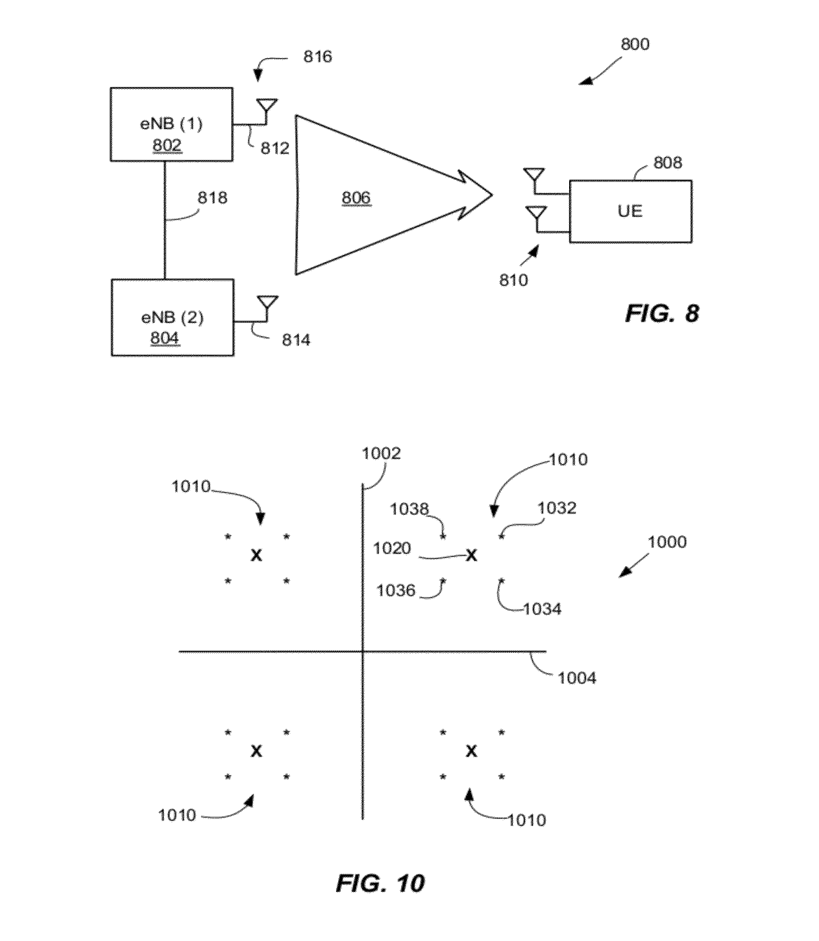

FIG. 8 illustrates an aspect that may be common to transmit diversity for eMBMS: the use of non co-located (i.e., remotely located) antennas as part of an antenna matrix for transmit diversity. The wireless communication system 800 comprises at least two eNBs 802, 804 connected in any suitable manner, for example through a backhaul connection 818. The connection 818 enables coordination of eMBMS signaling and transmit diversity using the remotely located antennas 812 and 814. Antenna 812 is controlled by and co-located with a first eNB 802, which may comprise a macro cell, femto cell, pico cell, HNB, or other access point. Antenna 814 is controlled by and co-located with a second eNB 804, which is also of any suitable type, and remotely located from the first eNB 802. The first eNB 802 controls eMBMS signaling from its antenna 812, and the second eNB controls eMBMS signaling from its antenna 814 in coordination with the first eNB 802, such that the two antennas 812, 814 act as a two-antenna matrix 816 for transmission of eMBMS signaling in a wireless beam 806 to any UE 808 that happens to be in range. The receiving UE 808 may be equipped with an antenna matrix 810 or a single antenna. It is assumed that the first eNB 802 and the second eNB 804 are in the same eMBMS area, and thus, are in possession of the same eMBMS information and transmitting the same eMBMS signaling in a synchronized fashion.

Transmit diversity in a system as illustrated by FIG. 8 may be implemented using a Space-Frequency Block Code (SFBC) technique executed on the subcarrier, according to:

$$\begin{matrix}Antenna 0 \\ Antenna 1\end{matrix} {[ \begin{matrix}{S}_{0} & {S}_{1} \\ - {S}_{1}^{*} & {S}_{1}^{*}\end{matrix} ]}^{} .$$

A drawback of SFBC is that a multiple antenna reference signal design is needed, with increased overhead.

In the alternative, or in addition, transmit diversity in a system as illustrated by FIG. 8 may be implemented using cyclic delay diversity (CDD) precoding. CDD may be used while maintaining the same reference signal structure as defined in 3GPP LTE Release 8. Performance gain may be negligible for any eMBMS channel subject to numerous transmission paths from multiple cells. Further details regarding CDD may be found in 3GPP TS 36.211 and in U.S. Pat. Publ. 2008/0192856.

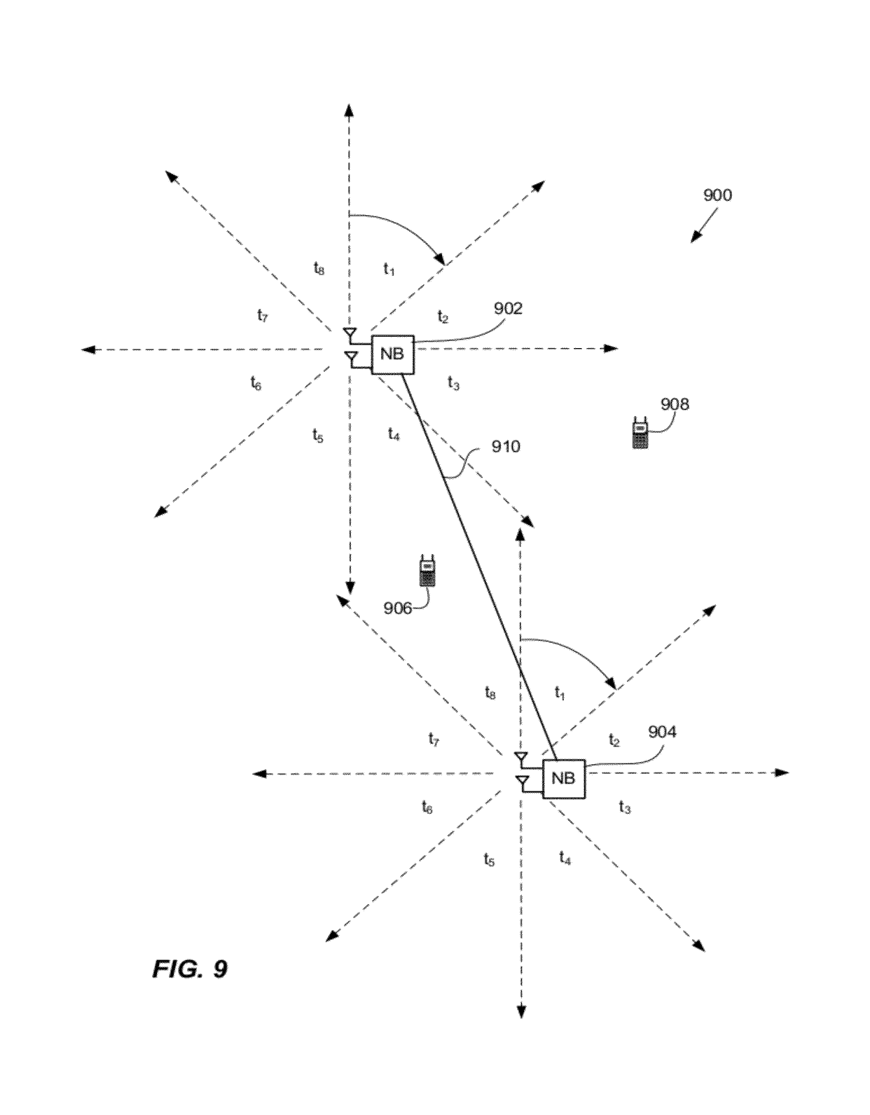

Beam steering using MIMO is another technique that can be applied in a novel way to enhance eMBMS. In a given eMBMS area with numerous UEs, each UE will receive different signal quality depending on its specific location. A beam steering technique using MIMO can be used to provide more uniform signal quality throughout an area. FIG. 9 illustrates an eMBMS area 900 including connected eNBs 902 and 904, each having a multiple antenna transmission matrix. Beam steering may be used so that each eNB in the eMBMS area rotates its transmission beam used for eMBMS signaling in a synchronized or non-synchronized fashion. FIG. 9 illustrates synchronized beam steering with 45° increments, dividing the circle into 8 octants per cycle. Four quadrants, two halves, 16 segments or some other number may be used, depending on the precoding matrix and number of antennas. The cycle is divided into time increments of t₁ to t₈ in the illustrated example. At time t₁, the UE 908 is in the transmission zone of the eMBMS signal from eNB 904, while the other UE 906 is not in any current transmission zone. At a later time t₃, the first UE 908 is in the transmission zone for 902 only. The second UE 906 is in the transmission zone of the first eNB 902 at time t₄, and in the transmission zone of the second eNB at time t₈.

Using MIMO to provide cyclic spatial multiplexing of eMBMS transmissions may provide a very high signal-to-noise ratio with MBSFN transmission. However, a new eMBMS reference signal design may be needed to support spatial multiplexing. Such a design should support up to two layer multiplexing with layer permutation and precoder cycling. Use of more than two layers may entail excessive reference signal overhead, and should be avoided. Different layers may be transmitted from different classes of eNBs in addition to different antennas within a eNB.

Different layers as provided by different classes of eNBs or different antennas of a eNB may be used to implement layered modulation for eMBMS transmissions. In these embodiments, legacy or low-grade receivers are able to demodulate only the eMBMS symbols transmitted on the higher energy layer. New or higher-end receivers are able to demodulate eMBMS symbols received on both lower and higher energy layers, and thus may receive enhanced service, for example higher-resolution displays or other additional information. FIG. 10 illustrates a symbol map 1000 with time/frequency axes 1002, 1004. Symbol clusters 1010 each comprise a high energy symbol 1020, received on a high energy base layer, and multiple lower energy symbols 1032, 1034, 1036 and 1038 (four in this example), received on a lower energy enhanced layer.

The base layer and its reference symbols may be the same as is Release 8 of 3GPP. The enhanced layer is superposed on the base layer. A suitably equipped receiver may use successive layer cancellation to decode both layers. Transmission antenna virtualization may be used to increase (e.g., maximize) transmission power.

In view of exemplary systems shown and described herein, methodologies that may be implemented in accordance with the disclosed subject matter will be better appreciated with reference to various flow charts. Although methodologies are shown and described as a series of acts/blocks for simplicity of illustration, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored as encoded instructions and/or data on an article of manufacture, for example, a non-transitory computer-readable medium, to facilitate storing, transporting and transferring such methodologies to various devices. Those skilled in the art will understand and appreciate that a method could alternatively be represented as a series of interrelated states or events, such as in a state diagram.

FIG. 11 shows a method 1100 for providing eMBMS using at least one network entity of a wireless communications system. The network entity and access node may each comprise a separate eNB of any of the various forms described herein. The method 1100 may include, at 1120, the network entity coordinating transmission of eMBMS signaling with an access node of a wireless communications system that is remotely located from the network entity to cause transmission from a multiple antenna matrix comprising at least one antenna of the network entity and at least one antenna of the access node. The method 1100 may further include, at 1140, the network entity providing transmit diversity for the eMBMS signaling transmitted from remotely located antennas of the antenna matrix. This may be done in cooperation with the access node. The method 1100 may further include, at 1160, the network entity communicating with the access node to coordinate eMBMS signaling within an eMBMS area of the wireless communication system. All described transmissions are performed wirelessly in accordance with one or more protocols described herein.

Coordinating eMBMS signaling may include, for example, coordinating signaling for providing the transmit diversity. For example, the network entity may vary a precoding vector applied to the eMBMS signaling to provide transmit diversity. Varying a precoding vector may include applying cyclic delay diversity of the transmitted signals. In the alternative, the network entity may provide transmit diversity by applying phase variation of the transmitted signals. In another alternative, the network entity may provide transmit diversity by implementing a Space-Frequency Block Coding (SFBC) technique.

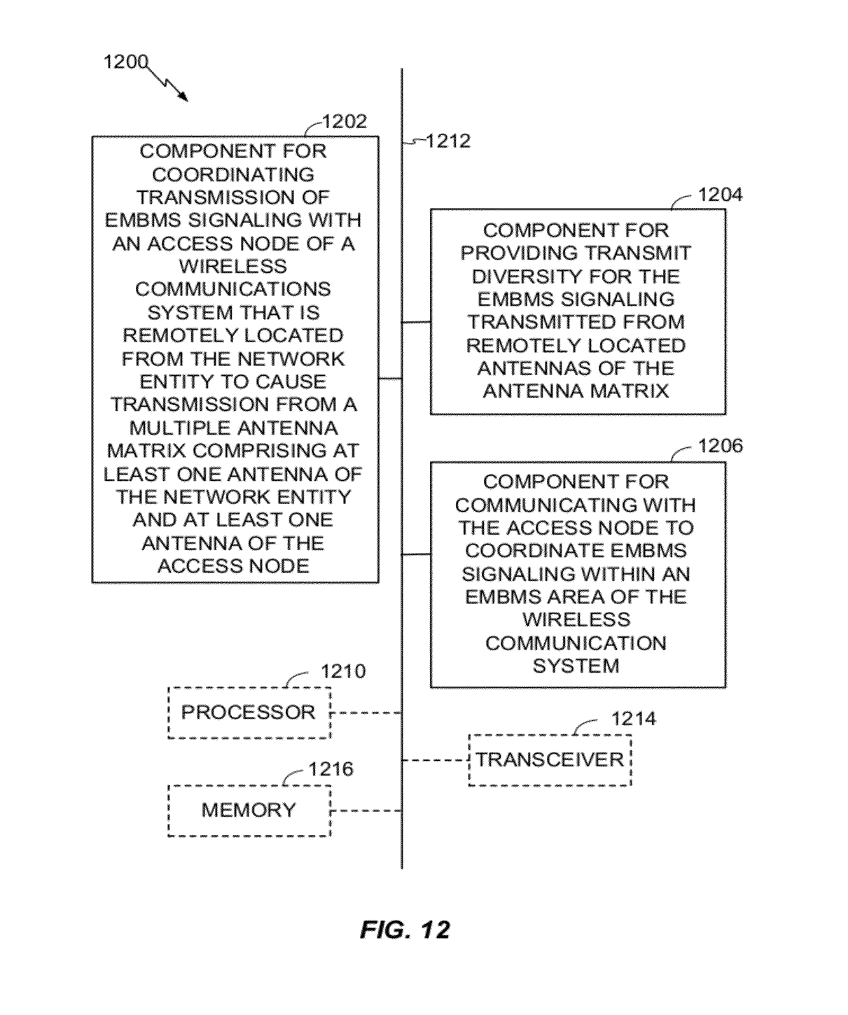

With reference to FIG. 12, there is provided an exemplary apparatus 1200 that may be configured as a network entity or eNB in a wireless network, or as a processor or similar device for use within the network entity or eNB, for providing eMBMS. The apparatus 1200 may include functional blocks that can represent functions implemented by a processor, software, or combination thereof (e.g., firmware).

As illustrated, in one embodiment, the apparatus 1200 may include an electrical component or module 1202 for coordinating transmission of eMBMS signaling with an access node of a wireless communications system that is remotely located from the network entity to cause transmission from a multiple antenna matrix comprising at least one antenna of the network entity and at least one antenna of the access node. For example, the electrical component 1202 may include at least one control processor coupled to a network interface or the like and to a memory with instructions for coordinating the eMBMS transmissions. The electrical component 1202 may be, or may include, a means for coordinating transmission of eMBMS signaling with an access node of a wireless communications system that is remotely located from the network entity to cause transmission from a multiple antenna matrix comprising at least one antenna of the network entity and at least one antenna of the access node. Said means may be or may include the at least one control processor operating an algorithm. The algorithm may include, for example, confirming a technique for coordinating a transmit diversity from multiple antennas controlled by different access points, wherein the technique is selected from one or more of varying a precoding vector, applying cyclic delay diversity, applying phase variation, or implementing an SFBC technique; and synchronizing diversity signals from the multiple access points.

The apparatus 1200 may include an electrical component 1204 for providing transmit diversity for the eMBMS signaling transmitted from remotely located antennas of the antenna matrix. For example, the electrical component 1204 may include at least one control processor coupled to a transceiver or the like, to an interface for the access node and to a memory holding instructions for providing transmit diversity from an antenna matrix. The electrical component 1204 may be, or may include, a means for providing transmit diversity for the eMBMS signaling transmitted from remotely located antennas of the antenna matrix. Said means may be or may include the at least one control processor operating an algorithm. The algorithm may include, for example, applying a selected precoding vector to information transmitted from an antenna of an access point, varying the precoding matrix according to a predetermined cycle, and synchronizing the cycle with one or more other access points.

The apparatus 1200 may include an electrical component 1206 for communicating with the access node to coordinate eMBMS signaling within an eMBMS area of the wireless communication system. For example, the electrical component 1206 may comprise at least one control processor coupled to an interface for the access node and to a memory holding instructions for communicating with the access node. The electrical component 1206 may be, or may include, a means for communicating with the access node to coordinate eMBMS signaling within an eMBMS area of the wireless communication system. Said means may be or may include the at least one control processor operating an algorithm. The algorithm may include, for example, identifying an eMBMS area for the eMBMS signaling by communicating with a network entity, and communicating with at least one access point in the eMBMS area to coordinate signaling for providing transmit diversity. For further example, said algorithm may include identifying the at least one access point, and defining a technique for providing transmit diversity, based on a signal from a network entity, for example, from a Multicast Coordinating Entity (MCE).

In related aspects, the apparatus 1200 may optionally include a processor component 1210 having at least one processor, in the case of the apparatus 1200 configured as a network entity or base station. The processor 1210, in such case, may be in operative communication with the components 1202-1206 or similar components via a bus 1212 or similar communication coupling. The processor 1210 may effect initiation and scheduling of the processes or functions performed by electrical components 1202-1206.

In further related aspects, the apparatus 1200 may include a radio transceiver component 1214. A stand alone receiver and/or stand alone transmitter may be used in lieu of or in conjunction with the transceiver 1214. The apparatus 1200 may optionally include a component for storing information, such as, for example, a memory device/component 1216. The computer readable medium or the memory component 1216 may be operatively coupled to the other components of the apparatus 1200 via the bus 1212 or the like. The memory component 1216 may be adapted to store computer readable instructions and data for performing the activity of the components 1202-1206, and subcomponents thereof, or the processor 1210, the additional aspects 1200, or the methods disclosed herein. The memory component 1216 may retain instructions for executing functions associated with the components 1202-1206. While shown as being external to the memory 1216, it is to be understood that the components 1202-1206 can exist within the memory 1216.

FIG. 1313 shows a method 1300 for MIMO transmission of eMBMS by at least one network entity of a wireless communications system. The network entity may comprise a eNB of any of the various forms described herein. The method 1300 may include, at 1310, the network entity coordinating transmission of eMBMS signaling with a remote access node of a wireless communications system to broadcast the eMBMS signaling from a multiple antenna matrix comprising at least one antenna of the network entity and at least one antenna of the remote access node. The method 1300 may further include, at 1320, varying a precoding matrix applied to eMBMS signaling to transmit from the network entity. This may be sufficient to, in general, enhance eMBMS transmission.

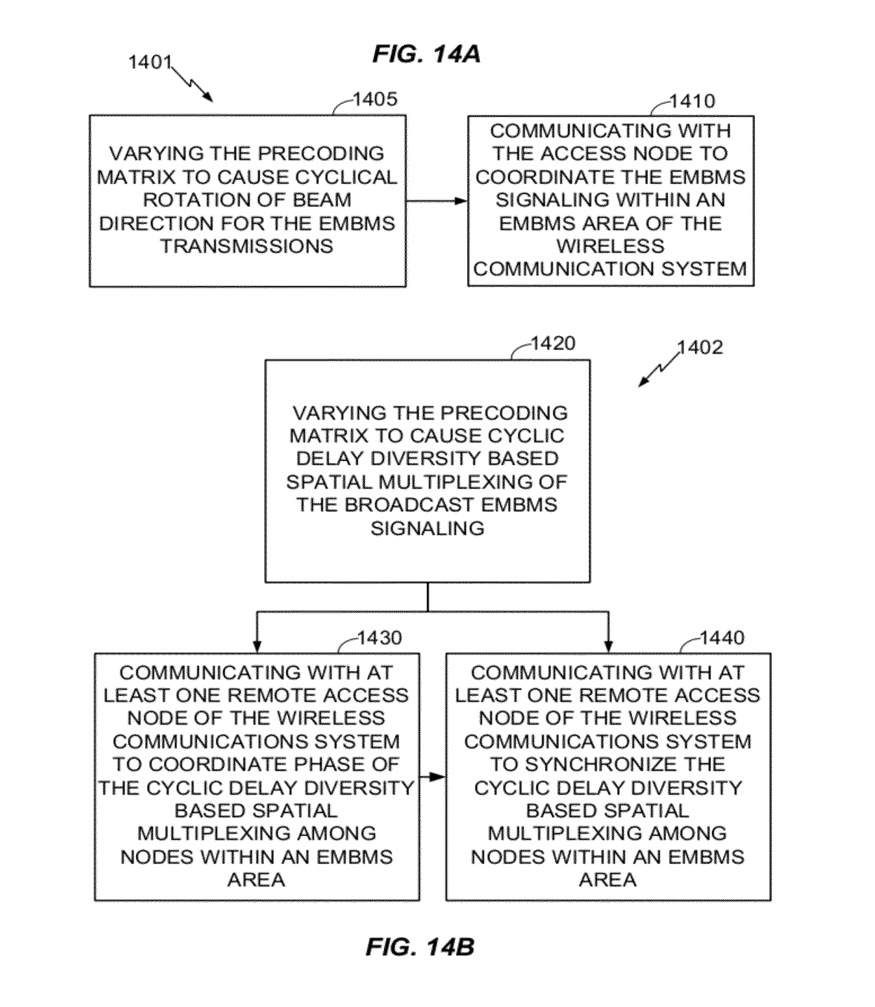

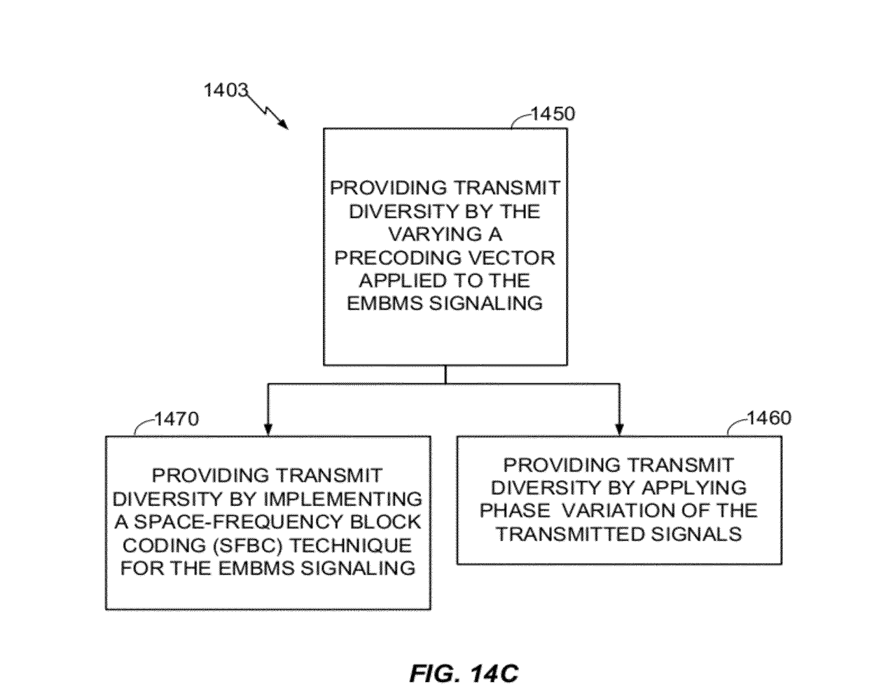

In addition, method 1300 may include further optional operations or aspects 1401, 1402 or 1403, as shown in FIGS. 14A-C. The blocks shown in FIGS. 14A-C are not required to perform the method 1300. Blocks are independently performed and not mutually exclusive, although blocks positioned directly on opposing branches off of an upstream block may be exclusive alternatives. In general, operations represented by any one block may be performed regardless of whether operations of another downstream or upstream block are performed. If the method 1300 includes at least one block of FIGS. 14A-C, then the method 1300 may terminate after the at least one block, without necessarily having to include any subsequent downstream block(s) that may be illustrated.

In an aspect, the method 1300 may include the additional operations 1401. The method 1300 may include, at 1405, the network entity varying the precoding matrix to cause cyclical rotation of beam direction for the eMBMS transmissions. The cyclical rotation may be coordinated so that the beam direction is aligned to corresponding sectors of the access node in a synchronized manner. In this arrangement, each location within the network may be within a beam from a different one of several nearby access nodes during corresponding periods of the cyclical rotation. Thus, a mobile entity may receive the eMBMS signaling from several different transmitters over each cycle, and may thereby avoid the disadvantage of receiving the eMBMS signaling from a single transmitter. Further details and alternative examples may be as described above in connection with FIG. 9.

In another aspect, the method 1300 may include, at 1410, communicating with the access node to coordinate (e.g., synchronize or coordinate phase of) the eMBMS signaling within an eMBMS area of the wireless communication system. For example, each access node may be assigned to a different angular offset of the cyclical rotation, and each offset assignment may be distributed over the eMBMS area to maximize coverage within the area. Special procedures may be adopted for access nodes located at or near the edge of the eMBMS area.

In another aspect, the method 1300 may include the additional operations 1402. The method 1300 may include, at 1420, the network entity varying the precoding matrix to cause cyclic delay diversity based spatial multiplexing of the broadcast eMBMS signaling. In addition, the method 1300 may further include, at 1430, the network entity communicating with at least one remote access node of the wireless communications system to coordinate phase of the cyclic spatial multiplexing among nodes within the eMBMS area. In the alternative, or in addition, the method 1300 may further include, at 1440, the network entity communicating with at least one remote access node of the wireless communications system to synchronize the cyclic spatial multiplexing among nodes within the eMBMS area.

In another aspect, the method 1300 may include the additional operations 1403 for providing transmit diversity for eMBMS signaling. The method 1300 may include, at 1450, providing transmit diversity by the varying a precoding vector applied to the eMBMS signaling transmitted from the multiple-antenna matrix distributed over two or more separate access points. In an alternative, the method 1300 may include, at 1460, providing transmit diversity by applying phase variation of the transmitted eMBMS signals from the multiple-antenna matrix distributed over two or more separate access points. In another alternative, the method 1300 may include, at 1470, providing transmit diversity for eMBMS signaling transmitted from the multi-antenna matrix by implementing an SFBC coding technique at the separate access points participating in the multi-antenna matrix.

In general, with reference to FIGS. 12 and 14B above, decision functionality with associated branching between two or more alternatives may be implemented by software, hardware, a combination thereof or any other suitable means (e.g., device, system, process, or component). Thus, for example, branching decisions may be made during execution by an entity performing other aspects of the described methods, may be predetermined by design prior to execution of other blocks, or may be accomplished by some combination of the foregoing over the various branching blocks.

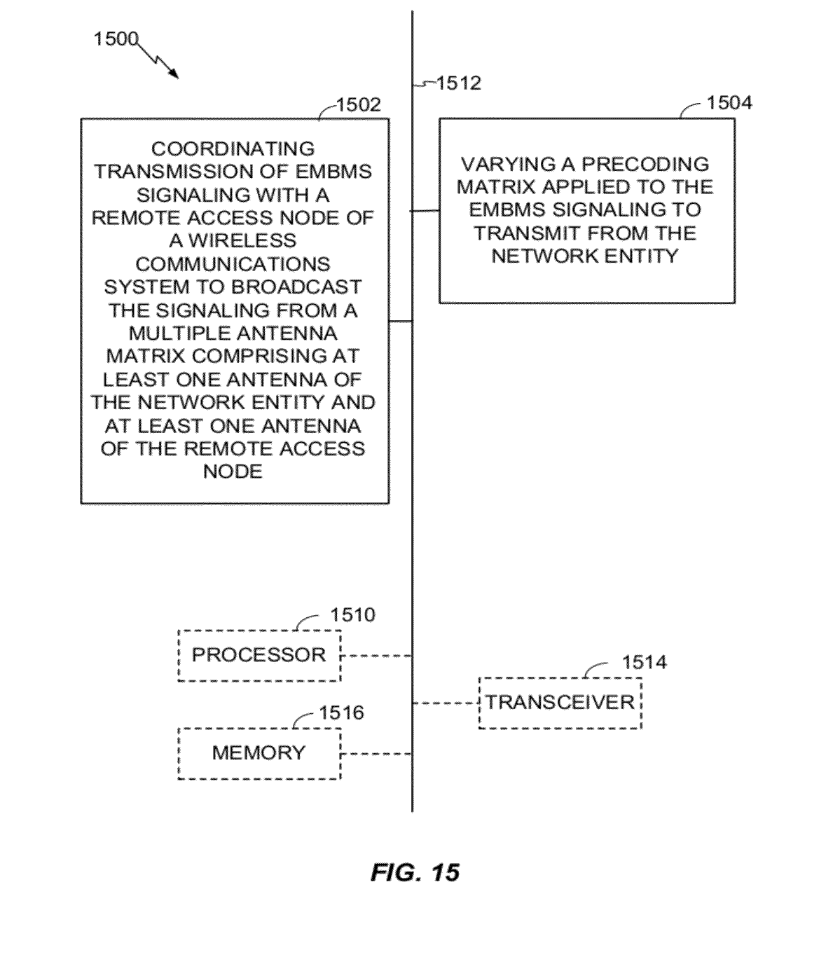

With reference to FIG. 15, there is provided an exemplary apparatus 1500 that may be configured as a network entity or eNB in a wireless network, or as a processor or similar device for use within the network entity or eNB, for providing eMBMS. The apparatus 1500 may include functional blocks that can represent functions implemented by a processor, software, or combination thereof (e.g., firmware).

As illustrated, in one embodiment, the apparatus 1500 may include an electrical component or module 1502 for coordinating transmission of eMBMS signaling with a remote access node of a wireless communications system to broadcast the eMBMS signaling from a multiple antenna matrix comprising at least one antenna of the network entity and at least one antenna of the remote access node. For example, the electrical component 1502 may include at least one control processor coupled to transceiver or the like and to a memory with instructions for coordinating transmission between two or more separate access points for broadcast of eMBMS signaling from at least one first antenna of a first access point and at least one second antenna of a second access point, wherein the first antenna and second antenna comprise a multiple antenna matrix. The electrical component 1502 may be, or may include, a means for coordinating transmission of eMBMS signaling with a remote access node of a wireless communications system to broadcast the eMBMS signaling from a multiple antenna matrix comprising at least one antenna of the network entity and at least one antenna of the remote access node. Said means may be or may include the at least one control processor operating an algorithm. The algorithm may include, for example, confirming a technique for coordinating transmission of eMBMS signaling from multiple antennas controlled by different access points, according to a defined rule set, and synchronizing the transmissions from the different access points according to the rule set.

In addition, the apparatus 1500 may include an electrical component 1504 for varying a precoding matrix to transmit from the network entity. For example, the electrical component 1504 may include at least one control processor coupled to a multiple-antenna transceiver or the like, and to a memory holding instructions for varying the precoding matrix. The electrical component 1504 may be, or may include, a means for varying a precoding matrix to transmit from the network entity. Said means may be or may include the at least one control processor operating an algorithm. The algorithm may include, for example, a table or other data structure holding defined variations of a precoding matrix, and cycling through the table or other data structure to select a variant of the precoding matrix to apply at each phase of the cycling, and applying the precoding matrix using matrix multiplication to precoded data.

In related aspects, the apparatus 1500 may optionally include a processor component 1510 having at least one processor, in the case of the apparatus 1500 configured as a network entity or base station. The processor 1510, in such case, may be in operative communication with the components 1502-1504 or similar components via a bus 1512 or similar communication coupling. The processor 1510 may effect initiation and scheduling of the processes or functions performed by electrical components 1502-1504.

In further related aspects, the apparatus 1500 may include a radio transceiver component 1514. A stand alone receiver and/or stand alone transmitter may be used in lieu of or in conjunction with the transceiver 1514. The apparatus 1500 may optionally include a component for storing information, such as, for example, a memory device/component 1516. The computer readable medium or the memory component 1516 may be operatively coupled to the other components of the apparatus 1500 via the bus 1512 or the like. The memory component 1516 may be adapted to store computer readable instructions and data for performing the activity of the components 1502-1504, and subcomponents thereof, or the processor 1510, or the methods disclosed herein and particularly any operation of the method 1300. The memory component 1516 may retain instructions for executing functions associated with the components 1502-1504. While shown as being external to the memory 1516, it is to be understood that the components 1502-1504 can exist within the memory 1516.

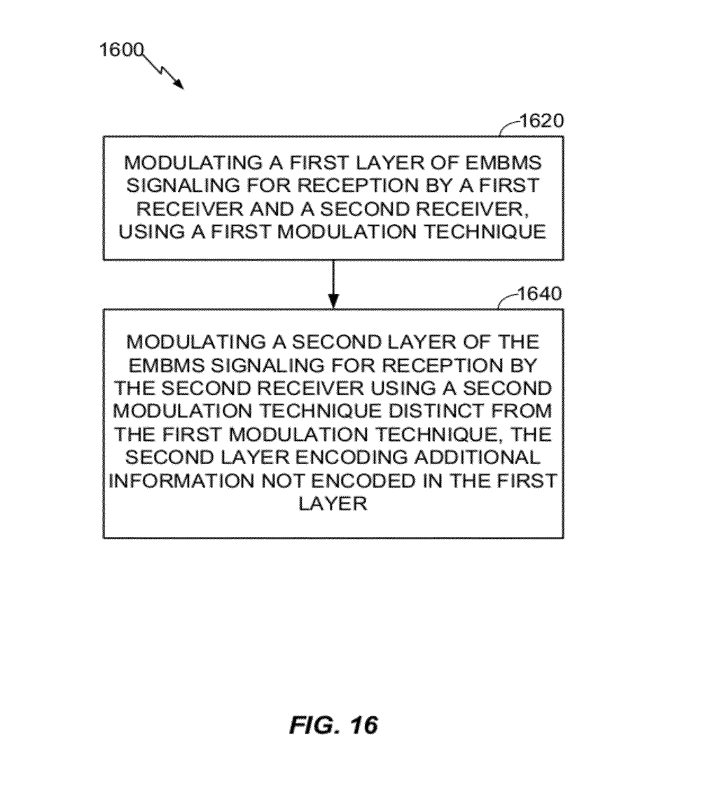

FIG. 16 shows a method 1600 for providing eMBMS using at least one network entity of a wireless communications system. The network entity may comprise a eNB of any of the various forms described herein. The method 1600 may include, at 1620, the network entity modulating a first layer of eMBMS signaling using a first modulation technique for reception by a first receiver and a second receiver. The method 1600 may further include, at 1640, the network entity modulating a second layer of the eMBMS signaling for reception by the second receiver using a second modulation technique distinct from the first modulation technique, the second layer encoding additional information not encoded in the first layer. Further details of modulating the first and second layers may be performed in as described above in connection with FIG. 10.

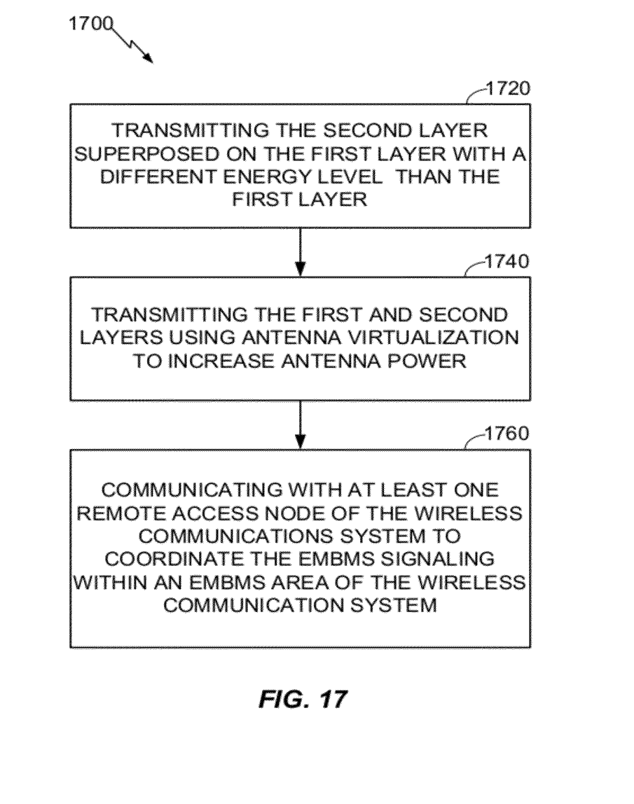

FIG. 17 shows further operations or aspects 1700 that may be performed by the network entity in conjunction with the method 1600 for providing eMBMS using at least one network entity of a wireless communications system. The operations or aspects 1700 are not required to perform the method 1600. Operations are independently performed and not mutually exclusive, although operations represented by blocks positioned directly on opposing branches off of an upstream block may be exclusive alternatives. In general, operations represented by any one block may be performed regardless of whether operations of another downstream or upstream block are performed. If the method 1600 includes at least one of the operations 1700, then the method 1600 may terminate after the at least one operation, without necessarily having to include any subsequent downstream operation(s) that may be illustrated.

The method 1600 may further include, at 1720, the network entity transmitting the second layer superposed on the first layer with a different energy level than the first layer. The method 1600 may further include, at 1740, the network entity transmitting the first and second layers using antenna virtualization to increase (for example, to maximize) antenna power. The method 1600 may further include, at 1760, the network entity communicating with at least one remote access node of the wireless communications system to coordinate the eMBMS signaling within an eMBMS area of the wireless communication system.

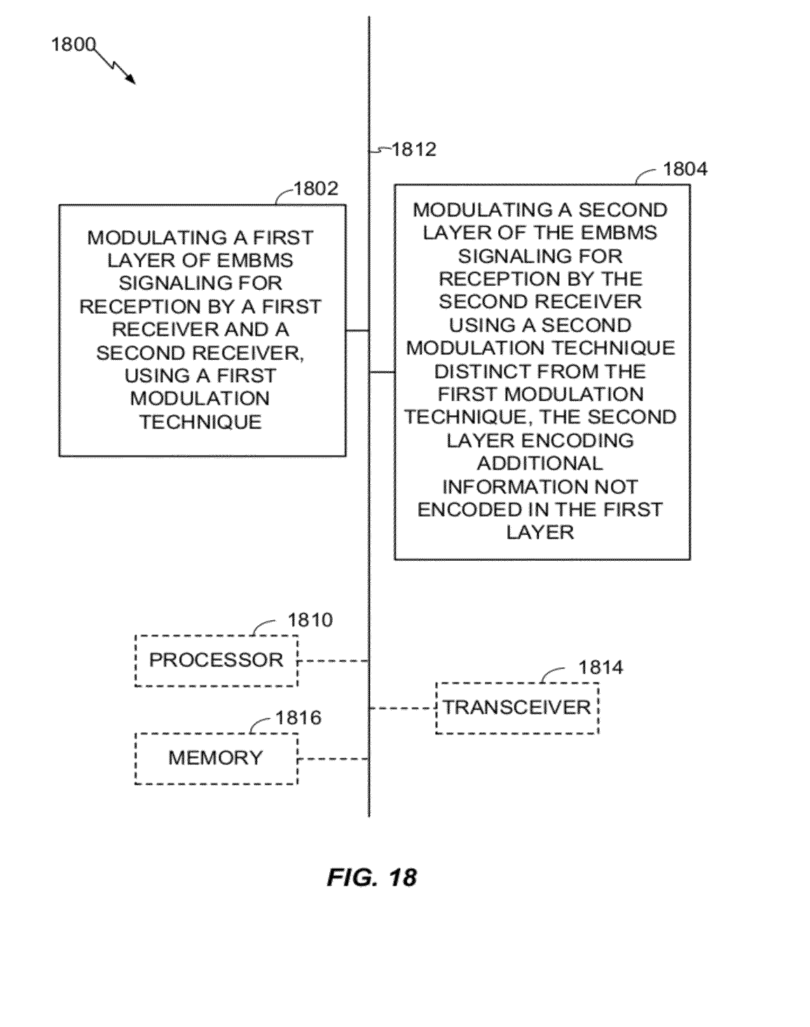

With reference to FIG. 18, there is provided an exemplary apparatus 1800 that may be configured as a network entity or eNB in a wireless network, or as a processor or similar device for use within the network entity or eNB, for providing eMBMS. The apparatus 1800 may include functional blocks that can represent functions implemented by a processor, software, or combination thereof (e.g., firmware).

As illustrated, in one embodiment, the apparatus 1800 may include an electrical component or module 1802 for modulating a first layer of eMBMS signaling for reception by a first receiver and a second receiver, using a first modulation technique. For example, the electrical component 1802 may include at least one control processor coupled to a transceiver or the like and to a memory with instructions for modulating the layer. The electrical component 1802 may be, or may include, a means for modulating a first layer of eMBMS signaling for reception by a first receiver and a second receiver. Said means may be or may include the at least one control processor operating an algorithm. The algorithm may include, for example, selecting a first portion of information for eMBMS broadcast for modulation using a first (e.g., high energy) modulation technique, and modulating the portion using the first modulation technique.

The apparatus 1800 may include an electrical component 1804 for modulating a second layer of the eMBMS signaling for reception by the second receiver using a second modulation technique distinct from the first modulation technique, the second layer encoding additional information not encoded in the first layer. For example, the electrical component 1804 may include at least one control processor coupled to a transceiver or the like and to a memory holding instructions for modulating the second layer. The electrical component 1804 may be, or may include, a means for modulating a second layer of the eMBMS signaling for reception by the second receiverusing a second modulation technique distinct from the first modulation technique, the second layer encoding additional information not encoded in the first layer. Said means may be, or may include, the at least one control processor operating an algorithm. The algorithm may include, for example, selecting a second portion of information for eMBMS broadcast for modulation using a second modulation technique, for example a low energy modulation technique, and modulating the second portion using the second modulation technique. The second modulation technique should be different from the first modulation technique, and enable the superposition of the low-energy modulated symbols around the high-energy modulated symbols in a time-frequency plane. An example of superposition of low-energy modulated symbols around the high-energy modulated symbols in a time-frequency plane is illustrated and described herein in connection with FIG. 10. The apparatus 1800 may include similar electrical components for performing any or all of the additional operations 1700 described in connection with FIG. 17, which for illustrative simplicity are not shown in FIG. 18.

In related aspects, the apparatus 1800 may optionally include a processor component 1810 having at least one processor, in the case of the apparatus 1800 configured as an access point. The processor 1810, in such case, may be in operative communication with the components 1802-1804 or similar components via a bus 1812 or similar communication coupling. The processor 1810 may effect initiation and scheduling of the processes or functions performed by electrical components 1802-1804.

In further related aspects, the apparatus 1800 may include a radio transceiver component 1814. A stand alone receiver and/or stand alone transmitter may be used in lieu of or in conjunction with the transceiver 1814. The apparatus 1800 may optionally include a component for storing information, such as, for example, a memory device/component 1816. The computer readable medium or the memory component 1816 may be operatively coupled to the other components of the apparatus 1800 via the bus 1812 or the like. The memory component 1816 may be adapted to store computer readable instructions and data for performing the activity of the components 1802-1804, and subcomponents thereof, or the processor 1810, the additional aspects 1700, or the methods disclosed herein. The memory component 1816 may retain instructions for executing functions associated with the components 1802-1804. While shown as being external to the memory 1816, it is to be understood that the components 1802-1804 can exist within the memory 1816.

FIG. 19 shows a method 1900 for processing eMBMS signals at a mobile entity of a wireless communications system. The mobile entity may comprise a UE or other mobile entity of any of the various forms described herein. The method 1900 may include, at 1920, the mobile entity demodulating a first layer of eMBMS signaling to obtain first eMBMS information, using a first demodulation technique adapted for the modulation technique used to modulate the first layer. The method 1900 may include, at 1940, the mobile entity demodulating a second layer of the eMBMS signaling to obtain additional eMBMS information not encoded in the first layer. In an aspect, the method 1900 may include, at 1960, the mobile entity demodulating the second layer that is superposed on the first layer and has a different energy level, using a second demodulation technique adapted for the modulation technique used to modulate the second layer, wherein the second demodulation technique is distinct from the first demodulation technique. Further details of demodulating the first and second layers may be performed in as described above in connection with FIG. 10.

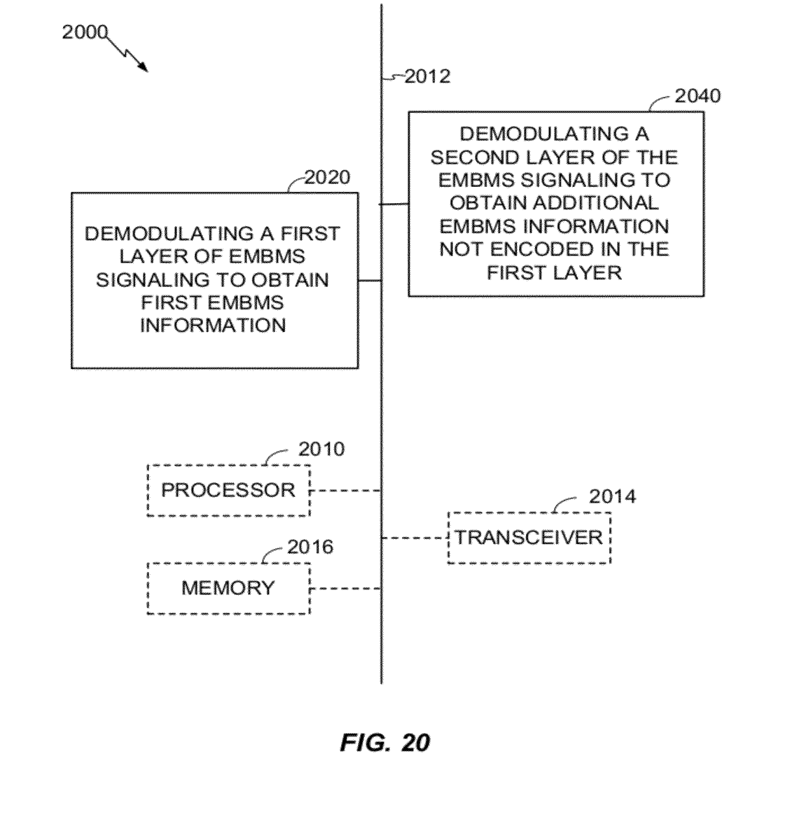

With reference to FIG. 20, there is provided an exemplary apparatus 2000 that may be configured as a UE or mobile entity in a wireless network, or as a processor or similar device for use within the mobile entity or UE, for processing eMBMS transmissions. The apparatus 2000 may include functional blocks that can represent functions implemented by a processor, software, or combination thereof (e.g., firmware).

As illustrated, in one embodiment, the apparatus 2000 may include an electrical component or module 2020 for demodulating a first layer of eMBMS signaling to obtain first eMBMS information. For example, the electrical component 2020 may include at least one control processor coupled to transceiver or the like and to a memory with instructions for demodulating the first layer. The electrical component 2020 may be, or may include, a means for demodulating a first layer of eMBMS signaling to obtain first eMBMS information. Said means may be or may include the at least one control processor operating an algorithm. The algorithm may include, for example, receiving a first portion of information in an eMBMS broadcast, demodulating the broadcast signal using a first (e.g., high energy) demodulation technique, and recovering the first portion of information thereby. The algorithm may further include, for example, receiving an identifier for the first modulation technique in association with the broadcast signal and selecting the first demodulation technique in response to the identifier. In an alternative, the algorithm may further include using a predetermined first demodulation technique for receiving eMBMS broadcasts generally.

The apparatus 2000 may also include an electrical component 2040 for demodulating a second layer of the eMBMS signaling to obtain additional eMBMS information not encoded in the first layer. For example, the electrical component 2040 may include at least one control processor coupled to a transceiver or the like, and to a memory holding instructions for demodulating the second layer. The electrical component 2040 may be, or may include, a means for demodulating a second layer of the eMBMS signaling to obtain additional eMBMS information not encoded in the first layer. Said means may be or may include the at least one control processor operating an algorithm. The algorithm may include, for example, receiving a second portion of information in an eMBMS broadcast, demodulating the broadcast signal using a second (e.g., low energy) demodulation technique, and recovering the second portion of information thereby. The algorithm may further include, for example, receiving an identifier for the second modulation technique in association with the broadcast signal and selecting the second demodulation technique in response to the identifier. In an alternative, the algorithm may further include using a predetermined second demodulation technique for receiving eMBMS broadcasts generally.

The second layer may be superposed on the first layer and have a different energy level. For example, the second demodulation technique may be use to demodulate the second portion of information in an eMBMS broadcast superposed over the first information in identical parts of the received broadcast signal. Demodulating the broadcast signal using the second (e.g., low energy) demodulation technique may include, for example, using successive layer cancellation to decode both layers, and recovering the first and second portions of information thereby.

In related aspects, the apparatus 2000 may optionally include a processor component 2010 having at least one processor, in the case of the apparatus 2000 configured as a mobile entity. The processor 2010, in such case, may be in operative communication with the components 2020-2060 or similar components via a bus 2012 or similar communication coupling. The processor 2010 may effect initiation and scheduling of the processes or functions performed by electrical components 2020-2060.

In further related aspects, the apparatus 2000 may include a radio transceiver component 2019. A stand alone receiver and/or stand alone transmitter may be used in lieu of or in conjunction with the transceiver 2019. The apparatus 2000 may optionally include a component for storing information, such as, for example, a memory device/component 2016. The computer readable medium or the memory component 2016 may be operatively coupled to the other components of the apparatus 2000 via the bus 2012 or the like. The memory component 2016 may be adapted to store computer readable instructions and data for performing the activity of the components 2020-2060, and subcomponents thereof, or the processor 2010, or the methods disclosed herein. The memory component 2016 may retain instructions for executing functions associated with the components 2020-2060. While shown as being external to the memory 2016, it is to be understood that the components 2020-2060 can exist within the memory 2016.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Non-transitory computer-readable media includes both computer storage media and temporary memory media that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blu-ray disc where “disks” usually refers to media that encode data magnetically, while “discs” usually refers to media that encodes data optically. Combinations of the above should also be included within the scope of non-transitory computer-readable media.

The previous description of the disclosure is provided to enable any person skilled in the art to make or use the disclosure. Various modifications to the disclosure such as are readily apparent to those skilled in the art, and the generic principles described herein may be applied to such variations without departing from the spirit or scope of the disclosure. Thus, the disclosure is not intended to be limited to the examples and designs described herein but should be accorded the widest scope consistent with the principles and novel features disclosed herein.

What is claimed is:

1. A method for transmission of Evolved Multimedia Broadcast Multicast Service (eMBMS) by a network entity of a wireless communications system, comprising:
coordinating transmission of eMBMS signaling with a remote access node of a wireless communications system to broadcast the eMBMS signaling from a multiple antenna matrix comprising at least one antenna of the network entity and at least one antenna of the access node; and
varying a precoding matrix applied to the eMBMS signaling to transmit from the network entity.

2. The method of claim 1, further comprising varying the precoding matrix to cause cyclical rotation of beam direction for the eMBMS transmissions.

3. The method of claim 1, further comprising communicating with the access node to coordinate the eMBMS signaling within an eMBMS area of the wireless communication system.

4. The method of claim 1, further comprising varying the precoding matrix to cause cyclic delay diversity based spatial multiplexing of the broadcast eMBMS signaling.

5. The method of claim 3, further comprising communicating with at least one remote access node of the wireless communications system to coordinate phase of the cyclic delay diversity based spatial multiplexing among nodes within an eMBMS area.

6. The method of claim 3, further comprising communicating with at least one remote access node of the wireless communications system to synchronize the cyclic delay diversity based spatial multiplexing among nodes within an eMBMS area.

7. The method of claim 1, further comprising providing transmit diversity by applying phase variation to the eMBMS signaling.

8. The method of claim 1, further comprising providing transmit diversity by implementing a Space-Frequency Block Coding (SFBC) technique for the eMBMS signaling.

9. An apparatus for transmission of Evolved Multimedia Broadcast Multicast Service (eMBMS) by a network entity of a wireless communications system, the apparatus comprising:
means for coordinating transmission of eMBMS signaling with a remote access node of a wireless communications system to broadcast the eMBMS signaling from a multiple antenna matrix comprising at least one antenna of the network entity and at least one antenna of the access node; and
means for varying a precoding matrix applied to the eMBMS signaling transmit from the network entity.

10. An apparatus for transmission of Evolved Multimedia Broadcast Multicast Service (eMBMS) by a network entity of a wireless communications system, comprising:
at least one processor configured to coordinate transmission of eMBMS signaling with a remote access node of a wireless communications system to broadcast the eMBMS signaling from a multiple antenna matrix comprising at least one antenna of the network entity and at least one antenna of the access node, and to vary a precoding matrix applied to eMBMS signaling to transmit from the network entity; and
a memory coupled to the at least one processor for storing data.

11. The apparatus of claim 10, wherein the processor is further configured for varying the precoding matrix so as to cause cyclical rotation of beam direction for the eMBMS transmissions.

12. The apparatus of claim 10, wherein the processor is further configured for communicating with the access node to coordinate the eMBMS signaling within an eMBMS area of the wireless communication system.

13. The apparatus of claim 10, wherein the processor is further configured for varying the precoding matrix to cause cyclic delay diversity based spatial multiplexing of the broadcast eMBMS signaling.

14. The apparatus of claim 13, wherein the processor is further configured for communicating with at least one remote access node of the wireless communications system to coordinate phase of the cyclic delay diversity based spatial multiplexing among nodes within an eMBMS area.

15. The apparatus of claim 13, wherein the processor is further configured for communicating with at least one remote access node of the wireless communications system to synchronize the cyclic delay diversity based spatial multiplexing among nodes within an eMBMS area.

16. The apparatus of claim 10, wherein the processor is further configured for providing transmit diversity by applying phase variation to the eMBMS signaling.

17. The apparatus of claim 10, wherein the processor is further configured for providing transmit diversity by implementing a Space-Frequency Block Coding (SFBC) technique for the eMBMS signaling.

18. A computer program product comprising:
a non-transitory computer-readable medium encoded with instructions that, when executed by a processor, cause a wireless transmitter to perform operations including coordinating transmission of Evolved Multimedia Broadcast Multicast Service (eMBMS) signaling with a remote access node of a wireless communications system to broadcast the eMBMS signaling from a multiple antenna matrix comprising at least one antenna of the wireless transmitter and at least one antenna of the access node, and varying a precoding matrix applied to the eMBMS signaling to cause cyclic spatial multiplexing of eMBMS transmissions from the multiple antenna matrix.

19. A method for transmission of Evolved Multimedia Broadcast Multicast Service (eMBMS) by a network entity of a wireless communications system, comprising:
modulating a first layer of eMBMS signaling for reception by a first receiver and a second receiver using a first modulation technique; and
modulating a second layer of the eMBMS signaling for reception by the second receiver using a second modulation technique distinct from the first modulation technique, the second layer encoding additional information not encoded in the first layer.

20. The method of claim 19, further comprising transmitting the second layer superposed on the first layer with a different energy level than the first layer.

21. The method of claim 19, further comprising transmitting the first and second layers using antenna virtualization to increase antenna power.

22. The method of claim 19, further comprising communicating with at least one remote access node of the wireless communications system to coordinate the eMBMS signaling within an eMBMS area of the wireless communication system.

23. An apparatus for transmission of Evolved Multimedia Broadcast Multicast Service (eMBMS) by a network entity of a wireless communications system, the apparatus comprising:
means for modulating a first layer of eMBMS signaling for reception by a first receiver and a second receiver, using a first modulation technique; and
means for modulating a second layer of the eMBMS signaling for reception by the second receiver using a second modulation technique distinct from the first modulation technique, the second layer encoding additional information not encoded in the first layer.

24. An apparatus for transmission of Evolved Multimedia Broadcast Multicast Service (eMBMS) by at least one network entity of a wireless communications system, comprising:
at least one processor configured to modulate a first layer of eMBMS signaling for reception by a first receiver and a second receiver using a first modulation technique, and to modulate a second layer of the eMBMS signaling for reception by the second receiver using a second modulation technique distinct from the first modulation technique, the second layer encoding additional information not encoded in the first layer; and
a memory coupled to the at least one processor for storing data.

25. The apparatus of claim 24, wherein the processor is further configured for transmitting the second layer superposed on the first layer with a different energy level than the first layer.

26. The apparatus of claim 24, wherein the processor is further configured for transmitting the first and second layers using antenna virtualization to increase antenna power.

27. The apparatus of claim 24, wherein the processor is further configured for communicating with at least one remote access node of the wireless communications system to coordinate the eMBMS signaling within an eMBMS area of the wireless communication system.

28. A computer program product comprising:
a non-transitory computer-readable medium encoded with instructions that, when executed by a processor, cause a wireless transmitter to perform operations including transmitting Evolved Multimedia Broadcast Multicast Service (eMBMS) signaling by modulating a first layer of eMBMS signaling for reception by a first receiver and a second receiver using a first modulation technique, and modulating a second layer of the eMBMS signaling for reception by the second receiver using a second modulation technique distinct from the first modulation technique, the second layer encoding additional information not encoded in the first layer.

29. A method for processing Evolved Multimedia Broadcast Multicast Service (eMBMS) signals at a mobile entity of a wireless communications system, comprising:
demodulating a first layer of eMBMS signaling to obtain first eMBMS information; and
demodulating a second layer of the eMBMS signaling to obtain additional eMBMS information not encoded in the first layer.

30. The method of claim 29, wherein the second layer is superposed on the first layer and with a different energy level than the first layer.

31. An apparatus for processing Evolved Multimedia Broadcast Multicast Service (eMBMS) signals at a mobile entity of a wireless communications system, the apparatus comprising:
means for demodulating a first layer of eMBMS signaling to obtain first eMBMS information; and
means for demodulating a second layer of the eMBMS signaling to obtain additional eMBMS information not encoded in the first layer.

32. An apparatus for processing Evolved Multimedia Broadcast Multicast Service (eMBMS) signals at a mobile entity of a wireless communications system, comprising:
at least one processor configured to demodulate a first layer of eMBMS signaling to obtain first eMBMS information, and to demodulate a second layer of the eMBMS signaling to obtain additional eMBMS information not encoded in the first layer; and
a memory coupled to the at least one processor for storing data.

33. The apparatus of claim 32, wherein the processor is further configured to demodulate the second layer superposed on the first layer and with a different energy level than the first layer.

34. A computer program product comprising:
a non-transitory computer-readable medium encoded with instructions that, when executed by a processor, cause a wireless receiver to perform operations including receiving Evolved Multimedia Broadcast Multicast Service (eMBMS) signals, and processing the eMBMS signals by demodulating a first layer of eMBMS signaling to obtain first eMBMS information, and demodulating a second layer of the eMBMS signaling to obtain additional eMBMS information not encoded in the first layer.
